(19) United States
(12) Patent Application Publication
(10) Pub. No.: US 2002/0066781 A1
(43) Pub. Date: Jun. 6, 2002

(54) LOST ARTICLE RETRIEVAL MEANS AND METHOD

(76) Inventors: Cathy D. Santa Cruz, Reno, NV (US); Lloyd E. Stanley, Reno, NV (US)

Correspondence Address: Cathy D. Santa Cruz, 7630 Tholl Drive, Reno, NV, 89506, US

(21) Appl. No.: 09/732,492

(22) Filed: Dec. 6, 2000

(51) Int. Cl. G06F 17/00

(52) U.S. Cl. 235/375

(57) ABSTRACT

This invention pertains to a device and method which encourages a finder of a lost item to return the item by way of the postal system to a recipient for a reward as compensation for their honesty, and thereafter the recipient forwards the lost article to the original owner.

### FIELD OF THE INVENTION

This invention relates to devices or methods used for returning a lost article to the original owner, but more specifically pertains to a means or method which encourages a finder of the lost item to return the item to its original owner for a reward as compensation in return.

### BACKGROUND OF THE INVENTION

It is well known by anyone having a personal item such as a wallet, purse, or the like, that if such an item is accidentally lost or stolen the chances for either finding it, or having the item returned is very unlikely. Thus, in most cases when such an item is lost or stolen the owner is very distraught as they not only have lost the item but also the contents thereof, which is in most cases consists of very personal items, such as credit cards, money, pictures, identification, etc.

Also, it is further very disturbing for the owner as it is most costly and time consuming to replace the item along with its contents. Therefore, the applicants contend that there is a great need for a method or device which enables the owner of a lost item to retrieve the item in an efficient timely manner which is not only helpful for the owner, but is also advantages for the finder.

Accordingly, the applicants have thoroughly researched and investigated any and all of the known prior art and we did not find anything which addresses a method or device for retrieving a lost item in the manner as taught herein. Nor did the applicants find anything which could be used in this manner, either as a method or as a device. Nor did the applicants find any reference which addresses or resolves the noted problem, nor do they achieve the unusual results and novel features as clearly inherent within the present invention. Thus, no pertinent cited prior art references are included within the application.

### SUMMARY OF THE INVENTION

It is therefore an object of the present invention to provide a lost article retrieval means and method which is very useful for the owner of the lost item and which encourages the finder to return the lost item to the owner.

It is another object of the present invention to provide a lost article retrieval means and method which is very inexpensive and easy to use.

Yet another object of the present invention is to provide a lost article retrieval means and method which incorporates the use of the United States postal service.

Still another object of the present invention is to provide a lost article retrieval means and method which is compact and can be easily stored within a compartment of the lost item, or easily fixedly attached thereon.

Also another object of the present invention is to provide a lost article retrieval means and method which includes easy registration and a personal account number.

Still another object of the present invention is to provide a lost article retrieval means and method that accomplishes novel and most unusual results which are heretofore not taught within the known prior art.

Yet another object of the present invention is to provide a lost article retrieval means and method which includes simple instructions for the finder to follow.

A very important object of the present invention is to provide a lost article retrieval means and method which does not cost the finder any money when they return the item. Therefore, if they follow the return instructions, they will receive compensation for their honesty, which is an incentive and also encourages good morals.

Still a further object of the present invention is to provide a lost article retrieval means and method that offers the owner of an item some security as they can feel confident that if the item is lost, it will be most likely be returned.

A very important object of the present invention is to provide a lost article retrieval means and method which recognizes a problem which has never been addressed within the known prior art and resolves the problem in a manner heretofore not taught.

Yet another important object of the present invention is to provide a lost article retrieval means and method which does not require any additional apparatus other than a personalized envelope having pertinent information thereon, which specifically identifies the original owner.

Another object of the present invention is to provide a lost article retrieval means and method wherein the above noted envelope can be used as a shipping label, such as in situations where the item to be returned is larger than the size of the return envelope.

Still another important object of the present invention is to provide a lost article retrieval means and method wherein the above noted pertinent information is only identifiable to the mail recipient. Thus, no personal information is revealed about the original owner on the envelope to anyone other than the recipient. Therefore, this method is very confidential and secure, not only for the sender but for the original owner as well.

A very important object of the present invention is to provide a lost article retrieval means and method which can be used for return of substantially any article of user choice. For example, the article can be a wallet, a purse, a briefcase, luggage, a cell phone, a laptop computer, a backpack, etc.

Also a further object of the present invention is to provide a lost article retrieval means and method which allows the sender to either provide a return address for receiving compensation, or donate the compensation to a charity of their choice, or they may remain anonymous if so desired.

Still another very important object of the present invention is to provide a lost article retrieval means and method wherein the original owner pays a pre-determined fee to the recipient, such as to the company in charge, which covers the cost of the noted return envelope and recordation thereof.

Another object of the present invention is to provide a lost article retrieval means and method wherein the above noted company determines if the noted pre-determined fee is to be paid only once upon registration, quarterly, or annually, etc, according to their choice.

Yet another object of the present invention is to provide a lost article retrieval means and method wherein the above noted company determines said fee according to the size of the item to be returned. For example, if the article is a wallet, the fee would be approximately $45.00, if it is a briefcase the fee would be approximately $175.00, etc.

Also, a further object of the present invention is to provide a lost article retrieval means and method wherein the reward monies are determined according to the size of the item to be returned. For example, if the item is a wallet, the reward would be approximately $20.00, or if it is a briefcase, the reward would be approximately $75.00, etc.

Other objects and advantages will be seen when taken into consideration with the following specification and drawings.

### BRIEF DESCRIPTION OF THE DRAWINGS

FIG. 1 is substantially an overview of the preferred embodiment depicting the front side of the return envelope.

FIG. 2 is substantially an overview of the preferred embodiment depicting the back side of the return envelope.

FIG. 3 is substantially a plan view for depicting the method steps used for returning the reward monies and the lost article.

### DETAILED DESCRIPTION OF THE DRAWINGS

Referring now in detail to the drawings wherein like characters refer to like elements throughout the various views.

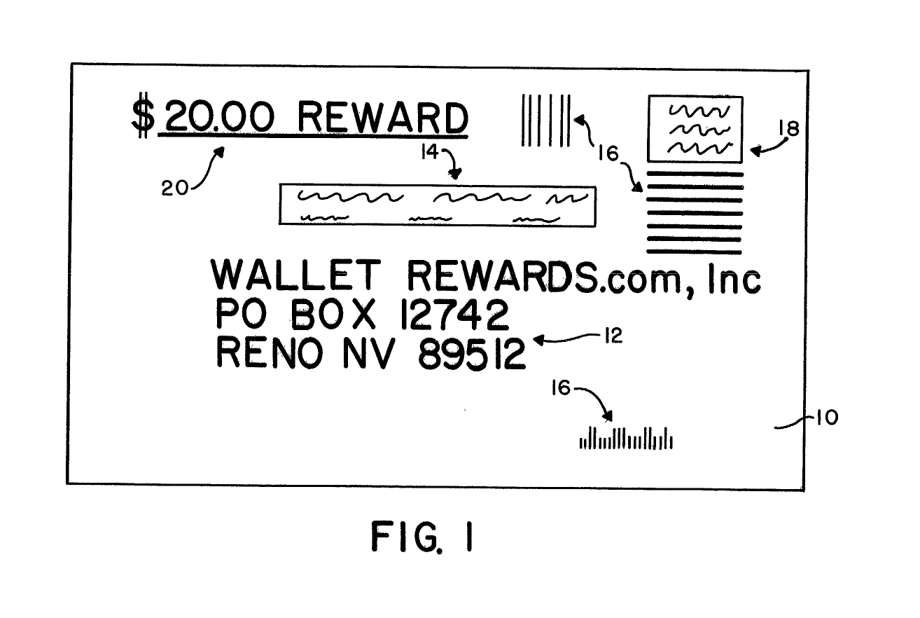

Regarding FIGS. 1 & 2, wherein depicted is substantially a front and back view of a typical pre-paid postage envelope (10) having pertinent indicia thereon. It is to be understood that envelope (10) can be of any suitable shape, size or type according to manufacturing choice. Thus, the envelope (10) as illustrated herein is only exemplary of one suitable embodiment and therefore the invention is not to be limited to that as depicted herein.

For example, as depicted herein envelope (10) is substantially of a sufficient size to contain a wallet or small purse. However, it is to be understood envelope (10) can be produced in various sizes of choice, so as to be of a sufficient size to contain other types of items therein, such as a cell phone, a diary, an address book, or the like.

Also, it is to be understood that if the item to be enclosed in envelope (10) is too large, then envelope (10) can be used as a shipping label as an alternative. Such a scenario would be appropriate for shipping a briefcase, a laptop computer, a backpack, etc.

Further regarding FIGS. 1 & 2, it is to be understood that the above noted indicia may represent any suitable pertinent information according to manufacturing choice. Thus, again the following indicia is only exemplary of one means for using indicia to reveal pertinent information.

Referring now in detail to FIG. 1, wherein envelope (10) includes typical indicia (12) thereon which informs the postal service of the recipient's address. While indicia (14) substantially informs the postal service that the return postage for envelope (10) is to be paid by the recipient, and may include a permit number and other information such as first-class mail, etc.

Further depicted within FIG. 1, envelope (10) includes indicia (16) which substantially represents typical standardized postal bar-codes, and indicia (18) substantially represents a box which is normally used for placement of a stamp, but in this case (18) indicates that “NO POSTAGE IS NECESSARY IF MAILED IN THE UNITED STATES”.

Furthermore as depicted in FIG. 1, envelope (10) also includes indicia (20) thereon, which informs the finder or sender that they will receive a reward if they return the item found to the original owner and may include the dollar amount they will receive.

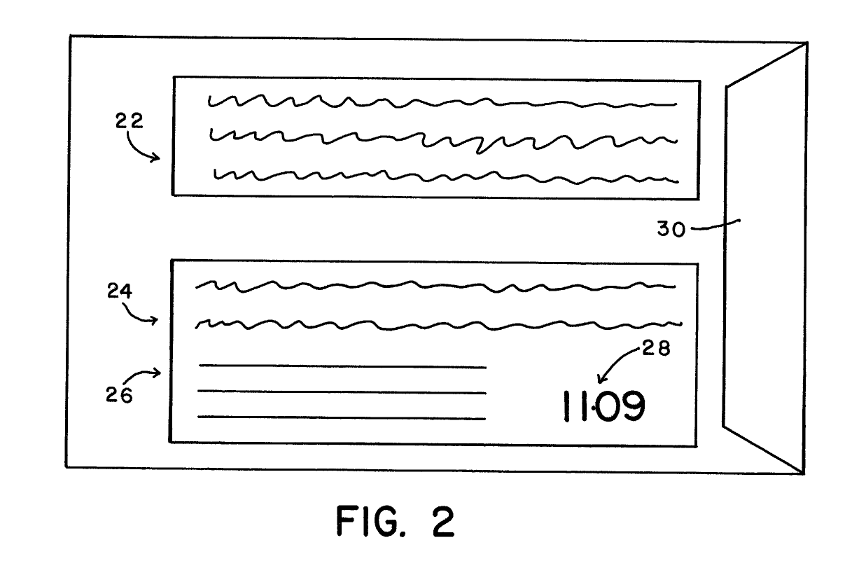

In reference now to FIG. 2, wherein envelope (10) further includes indicia (22) thereon which again can be indicative of any suitable information of choice. Such as indicia (22) may include information which instructs the finder of the lost item how they will be compensated if they follow the instructions and return the item to the original owner as follows: “As the finder of this wallet, regardless of the circumstances, WALLET REWARDS.COM, INC., will send to you a $20.00 REWARD for your time and effort. (NO QUESTIONS ASKED) all you need to do is place the wallet into this “WALLET RETURN ENVOLOPE”, write your name and address in the space provided below, seal it and drop it into the nearest mail box, postage pre-paid. If for any reason you would rather donate the $20.00 to a charity, write in the name of your favorite charity. If you feel a reward is not necessary, you need not put anything in the space provided below.”

It can now be seen the finder of the lost item is clearly informed that they should enclose the item within envelope (10), seal the envelope, and mail to the recipient at no cost to them. Thereafter, they will receive their compensation.

Envelope (10) as depicted in FIG. 2, further includes additional indicia (24) which provides further information of choice. Such as indicia (24) may state the following: “If the wallet or purse is too large for this envelope, you may wrap the object and use this envelope as a mailing label by taping this envelope to the outside of the package. If you would like to subscribe to our “WALLET REWARDS” program, you can contact us on the internet, at (www.walletrewards.com), or toll free by telephone, 1-877-925-5389 (1-887-WALLETZ).

As further depicted in FIG. 2, envelope (10) may also include indicia (26) thereon which may substantially represent the finder's return address, or the like. Still further information may include indicia (28), which might represent the registration or activation number of the owner of the lost item.

FIG. 2 also depicts a typical adhesive flap (30) which is used for closure of envelope (10), or other types of closure means may be used if so desired.

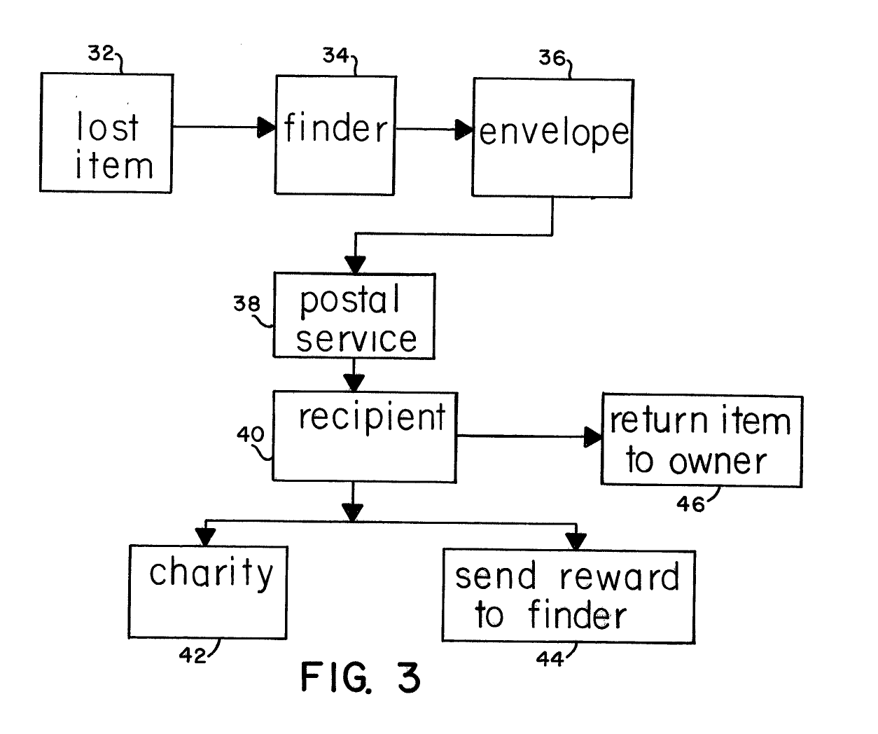

Referring now to the final drawing of FIG. 3, wherein we illustrate the appropriate steps for return of the lost item to the original owner, such as follows: (32) substantially represents the lost item, while (34) substantially represents the finder of the lost item. Thereafter, the finder (34) encloses the lost item (32) within envelope (10), seals the envelope (10) in the usual manner and mails the envelope (10) with the lost item (32) therein to the recipient (40) in the usual manner by way of the postal service (38). Once the recipient (40) receives the lost item (32), the recipient (40) will either donate the reward to the finder's favorite charity (42), or send the reward directly to the finder, as depicted by numeral (44). The recipient (40) also sends the lost item (32) to the original owner, as depicted by numeral (46).

It will now be seen the lost article retrieval means and method of the present invention includes the method steps as follows:

a. finding a lost article (32);

b. finding an instructional envelope (10), with envelope (10) either being contained within a compartment of the lost article (32), or envelope (10) is simply attached thereon;

c. reading the instructions on envelope (10);

d. following the instructions on envelope (10);

e. inserting the lost article (32) into envelope (10);

f. mailing the envelope (10) with the lost article (32) therein to the recipient (40);

g. mailing the reward (44) from the recipient (40) to the finder (34); and;

h. mailing the lost article (32) from the recipient (40) to the original owner (46).

It will also be seen we herein further include an alternative method for use of the lost article retrieval means and method of the present invention which includes the method steps as follows:

a. repeating steps a-f;

b. mailing the reward (44) from the recipient (40) to a charity (42); and;

c. mailing the lost article (32) from the recipient (40) to the original owner (46).

Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatuses.

WHAT WE CLAIM AS NEW and wish to secure by Letters Patent is:

1. A lost article retrieval means comprising: a pre-paid postage return envelope which is to be contained either within a compartment of a lost article or attached thereon, said envelope being of a shape and size to contain said lost article therein, said envelope having indicia thereon which informs the postal service of the recipient's address, and said envelope having indicia thereon which informs the finder of said lost article that they will receive a reward if they return said lost article to said recipient's address using said pre-paid postage envelope,
whereby:
said finder of said lost article is clearly informed that said finder should enclose said lost article within said envelope, seal said envelope, mail to said recipient at no cost too said finder, and thereafter said finder will receive said reward.

2. The lost article retrieval means of claim 1 wherein said lost article is either a wallet, a purse, a cell phone, or a diary.

3. A lost article retrieval means comprising: an envelope which can be used as a shipping label, said envelope is to be contained either within a compartment within a lost article or attached thereon, said envelope having indicia thereon which informs the postal service of the recipient's address, said envelope having indicia thereon which informs the finder of said lost article that they will receive a reward if they return said article to said recipient's address, said envelope having indicia thereon which informs said postal service that the return postage for said lost article is to be paid by the recipient, said envelope having indicia thereon which represents a permit number, said envelope having indicia thereon which represents standardized postal bar-codes, said envelope having indicia thereon which informs said finder that no postage is necessary if mailed in the United States, said envelope having indicia thereon which represents a registration number for identifying the original owner, and said envelope having indicia thereon which informs said finder of said article how they will be compensated if they follow the instructions and return said lost article to said recipient,
whereby:
said finder of said lost article is clearly informed that said finder should mail said lost article to said recipient at no cost too said finder, and thereafter said finder will receive said reward.

4. The lost article retrieval means of claim 3 wherein said lost article is either a briefcase, a backpack, or a laptop computer.

5. The lost article retrieval means of claim 3 further includes said envelope having additional indicia thereon which informs said finder if so desired, said reward can be donated to a favorite charity.

6. A method for using a lost article retrieval means, comprising the steps of:
a. finding a lost article;
b. finding an instructional envelope, with said envelope either being contained within a compartment of said lost article, or said envelope is simply attached thereon;
c. reading the instructions on said envelope;
d. following said instructions on said envelope;
e. inserting said lost article into said envelope;
f. mailing said envelope with said lost article therein to the recipient;
g. mailing a reward from said recipient to said finder; and;
h. mailing said lost article from said recipient to the original owner.
